(19) United States
(12) Patent Application Publication
(10) Pub. No.: US 2012/0023533 A1
(43) Pub. Date: Jan. 26, 2012

(54) METHOD AND APPARATUS FOR DELIVERY OF INTERNET PROTOCOL TELEVISION SERVICE

(75) Inventors: Shengqiang Wang, Cary, NC (US); Martin J. Rademacher, Raleigh, NC (US)

(73) Assignee: ALCATEL-LUCENT USA INC., Murray Hill, NJ (US)

(21) Appl. No.: 12/841,450

(22) Filed: Jul. 22, 2010

(51) Int. Cl. H04N 7/173

(52) U.S. Cl. 725/109

(57) ABSTRACT

A method and apparatus for delivery of internet protocol television (IPTV) service are provided. The method may include receiving an IPTV unicast video stream of a select video content from an IPTV server associated with a third party IPTV service provider at a proxy server within a core network associated with an internet access provider, converting the select video content from the IPTV unicast video stream to an IPTV multicast video stream at the proxy server, and sending the IPTV multicast video stream of the select video content from the proxy server to each of multiple subscribers of the third party IPTV service provider at a respective subscriber device associated with the corresponding multiple subscriber via the core network using a multicast IP addressing scheme. The apparatus may include a proxy server with a third party IPTV interface module, a conversion module, and a subscriber interface module.

### BACKGROUND

This disclosure relates to a method and apparatus for delivery of internet protocol television (IPTV) service from a third party IPTV service provider to its subscribers through an internet access provider. The third party IPTV service provider sends an IPTV unicast video stream to the internet access provider. The internet access provider converts the IPTV unicast video stream to an IPTV multicast video stream and sends the IPTV multicast video stream to third party IPTV subscribers that requested the corresponding video content. For example, this disclosure describes exemplary embodiments in which the IPTV service is provided via network architectures that include a fiber optic network, a digital subscriber line (DSL) network, or a cable television (TV) network. However, the IPTV service may be provided using any type of network architecture in any combination that is suitable for delivery of streaming video to subscribers.

By way of background, IPTV service is commonly offered by fixed access internet service providers (ISPs) (i.e., internet access providers). However, more and more third parties, such as KylinTV, are offering IPTV service that is accessible through internet access providers. The difference between ISPs providing IPTV service and third party IPTV service providers providing IPTV service are described below.

For ISPs providing IPTV service, the downstream IPTV traffic may be either broadcast or multicast to the set top boxes (STBs) of subscribers with guaranteed quality of service because the bandwidth for this traffic is reserved.

However, because the broadcast and multicast traffic from third parties is strictly controlled by ISPs, third party IPTV providers use unicast for IPTV service delivery. This IPTV service delivery mechanism has two dramatic problems—wasted bandwidth and no guarantee on quality of service. Regarding wasted bandwidth, users watching the same channel need duplicated unicast streams from the third party IPTV service provider even though each unicast stream delivers the same information. Regarding quality of service, ISPs specify the maximum bandwidth for internet service profiles for downstream unicast traffic to customers' devices such as STBs. Under these circumstances, the ISPs cannot provide guaranteed quality of service for IPTV service provided via unicast streams.

For example, Time Warner Cable provides service profiles with the maximum bandwidths of 7 Mbps, 3 Mbps, 1.5 Mbps, or 768 Kbps and AT&T DSL provides service profiles with the maximum bandwidths of 6 Mbps, 3 Mbps, 1.5 Mbps, or 768 Kbps. However, the real time allocated bandwidth is not guaranteed at the maximum bandwidth level all the time. The bandwidth is determined by traffic nature at a time on the access node, such as an optical line termination (OLT), DSL access modem (DSLAM), or cable modem termination (see FIG. 1). Internet traffic, including unicast third party IPTV traffic, is delivered using best effort of quality of service. When other users have higher downloading/streaming activities, users receiving IPTV unicast streams from third party IPTV service providers may not get enough bandwidth and hence may suffer video freezing or other types of defects resulting in undesirable quality of service.

With reference to FIG. 1, an exemplary embodiment of an existing communication system 10 for providing third party IPTV service to subscribers includes a third party IPTV service provider 12, an ISP core network 14, a local office access network node 16, and an subscriber device 18. The communication system 10 implements an existing technique for the third party IPTV service provider 12 to deliver IPTV service via multiple IPTV unicast video streams to corresponding subscribers using corresponding subscriber devices 18 via the ISP core network 14. The ISP core network 14 includes routers, switches, dynamic host control protocol (DHCP) servers, etc. The local office access network node 16, for example, includes an OLT, DSLAM, or cable modem termination. The subscriber device 18 includes a network interface device 20 and a user device 22. The network interface device 20, for example, includes an optical network terminal (ONT), DSL modem, or cable modem. The user device 22, for example, includes an STB and a TV. The local office access network node 16 and network interface device 20 are managed by the ISP (i.e., internet access provider).

With continuing reference to FIG. 1, the third party IPTV traffic is sent from the third party IPTV service provider 12 to the ISP core network 14 through either public communication networks (e.g., Internet clouds) or a dedicated communication line. Third party IPTV service providers 12 negotiate the upload bandwidth to guarantee the IPTV traffic can be uploaded to ISP core network 14 with quality of service. However, as mentioned above, there is no guarantee for quality of service in the downstream path from the ISP core network 14 through the local office access network node 18 and network interface device 20 to the user device 22 for IPTV unicast traffic.

Based on the foregoing, there is a need for resolving quality of service issues in the downstream path for third party IPTV service from the ISP core network 18 to the user device 22. Additionally, there is a need to improve bandwidth efficiency in the downstream path from the ISP core network 18 to the user device 22 in relation to providing third party IPTV service.

### SUMMARY

In one aspect, a method for delivery of IPTV service is provided. In one embodiment, the method includes: a) receiving an IPTV unicast video stream of a select video content from an IPTV server associated with a third party IPTV service provider at a proxy server within a core network associated with an internet access provider, the IPTV unicast video stream having a unicast internet protocol (IP) addressing scheme, wherein the third party IPTV service provider offers an IPTV service that supplements other services offered by the internet access provider, b) converting the select video content from the IPTV unicast video stream to an IPTV multicast video stream at the proxy server, the IPTV multicast video stream having a multicast IP addressing scheme, and c) sending the IPTV multicast video stream of the select video content from the proxy server to each of multiple subscribers of the third party IPTV service provider at a respective subscriber device associated with the corresponding multiple subscriber via the core network using the multicast IP addressing scheme.

In another aspect, an apparatus for delivery of IPTV service is provided. In one embodiment, the apparatus includes a proxy server within a core network associated with an internet access provider. In one embodiment, the proxy server includes: a third party IPTV interface module for receiving an IPTV unicast video stream of a select video content from an IPTV server associated with a third party IPTV service provider, the IPTV unicast video stream having a unicast IP addressing scheme, wherein the third party IPTV service provider offers an IPTV service that supplements other services offered by the Internet access provider; a conversion module in operative communication with the third party IPTV interface module for converting the select video content from the IPTV unicast video stream to an IPTV multicast video stream, the IPTV multicast video stream having a multicast IP addressing scheme; and a subscriber interface module in operative communication with the conversion module for sending the IPTV multicast video stream of the select video content from the proxy server to each of multiple subscribers of the third party IPTV service provider at a respective subscriber device associated with the corresponding multiple subscriber via the core network using the multicast IP addressing scheme.

In yet another aspect, a method for delivery of IPTV service is provided. In one embodiment, the method includes: a) receiving subscriber information from an IPTV server associated with a third party IPTV service provider at a proxy server within a core network associated with an internet access provider for each of multiple subscribers of the third party IPTV service provider in relation to the corresponding subscriber signing up with the third party IPTV service provider as a new customer via the core network using a respective subscriber device, wherein the third party IPTV service provider offers an IPTV service that supplements other services offered by the internet access provider, b) receiving a source message from the IPTV server at the proxy server, the source message comprising a source IP address and a source port associated with the IPTV server for an IPTV unicast video stream of a select video content, c) receiving the IPTV unicast video stream of the select video content from the IPTV server at the proxy server, the IPTV unicast video stream having a unicast IP addressing scheme, d) converting the select video content from the IPTV unicast video stream to an IPTV multicast video stream at the proxy server, the IPTV multicast video stream having a multicast IP addressing scheme, e) receiving a multicast request to join the IPTV multicast video stream for each of the multiple subscribers from the respective subscriber device for the corresponding multiple subscriber via the core network, f) sending the IPTV multicast video stream of the select video content from the proxy server to each of the multiple subscribers to the respective subscriber device associated with the corresponding multiple subscriber via the core network using the multicast IP addressing scheme, and g) sending a stop message to the IPTV server from the proxy server to end the IPTV unicast video stream of the select video content from the IPTV server in response to determining the subscriber devices associated with the multiple subscribers that joined the IPTV multicast video stream are no longer connected to the IPTV multicast video stream. In this embodiment, the receiving in c) begins after the IPTV server receives a content request for the select video content from at least a first subscriber of the multiple subscribers using corresponding subscriber devices to access the IPTV server through the internet access provider via the core network.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an exemplary embodiment of an existing communication system for providing third party IPTV service to subscribers via multiple unicast video streams;

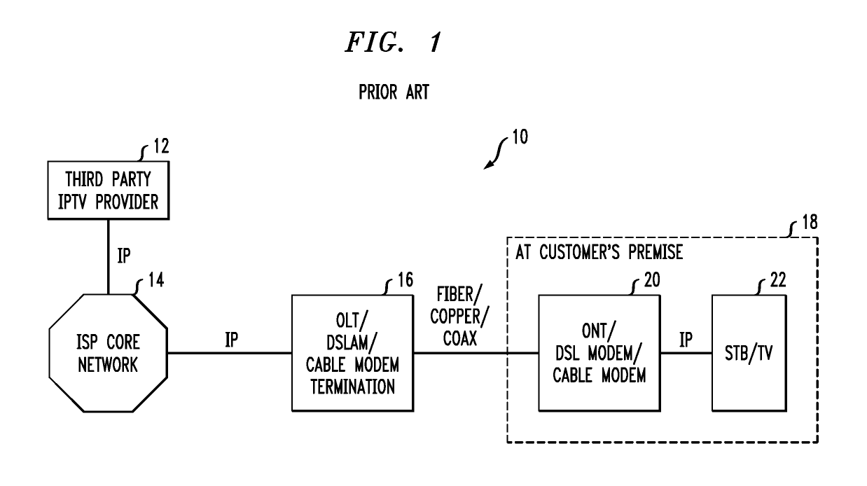

FIG. 2 is a block diagram of an exemplary embodiment of a communication system for providing third party IPTV service to subscribers via a multicast video stream;

FIG. 3 is a signal flow diagram for an exemplary embodiment of a communication system and associated process for providing third party IPTV service to subscribers via a multicast video stream;

FIG. 4 is a flow chart of an exemplary embodiment of a process for providing third party IPTV service to subscribers via a multicast video stream;

FIG. 5 is a block diagram of a communication system for providing third party IPTV service to subscribers via a multicast video stream; and

FIG. 6 is a flow chart of another exemplary embodiment of a process for providing third party IPTV service to subscribers via a multicast video stream.

### DETAILED DESCRIPTION

Various embodiments of methods and communication systems for providing third party IPTV service to subscribers via a multicast video stream are disclosed herein. The various embodiments describe how a third party IPTV service provider sends an IPTV unicast video stream to an internet access provider and how the internet access provider converts the IPTV unicast video stream to an IPTV multicast video stream and sends an IPTV multicast video stream to third party IPTV subscribers that requested the corresponding video content. Certain embodiments describe how this IPTV service is provided via network architectures that include a fiber optic network, a DSL network, or a cable TV network. Other embodiments describe how this IPTV service may be provided using any type of network architecture in any combination that is suitable for delivery of streaming video to subscribers, including any combination of a local area network (LAN), a TV network, a telephone network, and a wireless network. For example, a WiFi network, a WiMAX network, a cellular telephone network, or a satellite TV network may be implemented in a network architecture that provides the techniques for providing third party IPTV service described herein.

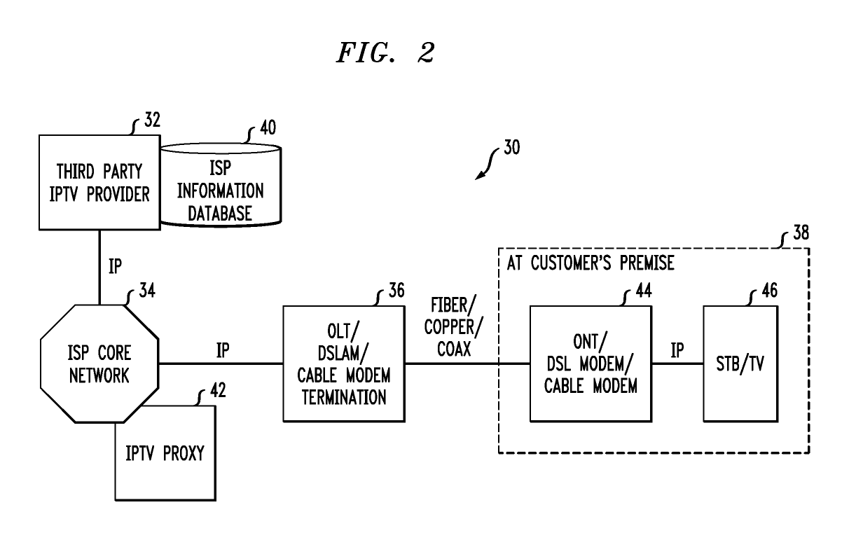

With reference to FIG. 2, an exemplary embodiment of a communication system 30 for providing third party IPTV service to subscribers includes a third party IPTV service provider 32, an ISP core network 34, a local office access network node 36, and an subscriber device 38. The communication system 30 implements a technique for the third party IPTV service provider 32 to deliver IPTV service via an IPTV multicast video stream to multiple subscribers using corresponding subscriber devices 38 via the ISP core network 34. The third party IPTV service provider 32 includes an IPTV server and a database 40 for storing third party IPTV subscriber information. The database 40 may also store certain ISP information relating to the third party IPTV subscribers and the third party IPTV service. The ISP core network 34 includes a proxy server 42 and may also include routers, switches, dynamic host control protocol (DHCP) servers, etc. The local office access network node 36, for example, may include an OLT, DSLAM, or cable modem termination. The subscriber device 38 may include a network interface device 44 and a user device 46. The network interface device 44, for example, may include an optical network terminal (ONT), DSL modem, or cable modem. The user device 46, for example, may include an STB and a TV.

The proxy server 42 can be introduced in the ISP core network 34 as an add-on component of existing routers or network nodes or as a separate network node. The proxy server 42 is maintained by the corresponding ISP and can communicate with one or more IPTV servers associated with the corresponding third party IPTV service provider 32.

The introduction of the proxy server 42 resolves at least two dramatic problems encountered by today's third party IPTV service providers. First, the proxy server 42 maintains available IP multicast group IP addresses for third party IPTV services and IP multicast group subscription status for access to such addresses. In cooperation with the proxy server 42, the IPTV server 40 maintains a database for storing various information related to the providing the third party IPTV service, including: i) IP address ranges for third party IPTV subscribers (i.e., customers), ii) IP addresses, ports, and communication protocols for proxy servers 42 with which the third party IPTV service is associated, and iii) available IP multicast group IP addresses associated with ISPs with which the third party IPTV service is associated (if the corresponding ISP does not use the proxy server 42 to dynamically assign IP multicast group IP addresses).

In this embodiment, the IPTV server for the third party IPTV service provider 32 sends one IPTV unicast video stream to the proxy server 42 in the ISP core network 34. The proxy server 42 converts the IPTV unicast video stream to an IPTV multicast video stream. Therefore, bandwidth is not wasted by for additional unicast streams with the same video content when the corresponding video content is delivered to multiple subscribers. Furthermore, because the desired video content is delivered to subscribers as multicast traffic, in ISP reserves bandwidth through the IPS core network 34 for the IPTV multicast video stream and quality of service is guaranteed.

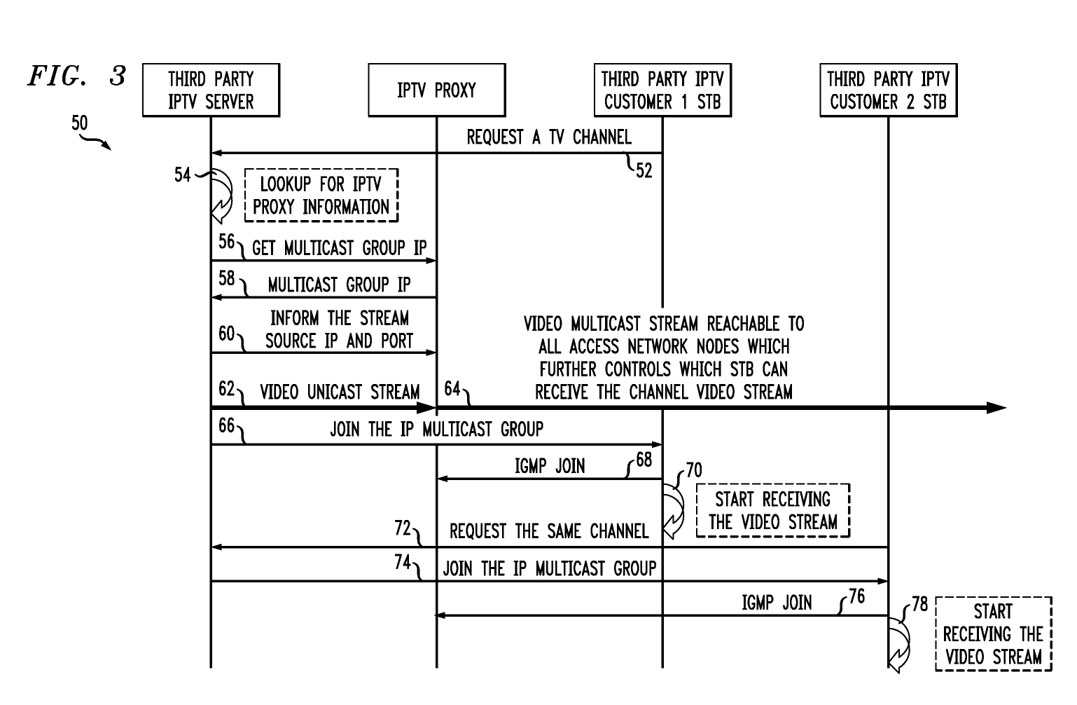

With reference to FIG. 3, an exemplary embodiment of a process 50 for providing third party IPTV service to subscribers is illustrated in a signal flow diagram showing communications between an IPTV server associated with the third party IPTV service provider 32, a proxy server 42 associated with the ISP (i.e., internet access provider), and subscriber devices 38 (e.g., STBs) associated with multiple third party IPTV subscribers. Prior to the signaling shown in signaling flow diagram, when the third party IPTV service provider adds a new subscriber (i.e., customer), the third party IPTV service provider programmatically communicates the corresponding subscriber information to the ISP with which the subscriber is also associated. This allows the corresponding ISP to enable signaling (e.g., internet group management protocol (IGMP) signaling) for the new subscriber in relation to the third party IPTV service. In one embodiment, the IPTV service associated with the third party IPTV service provider communicates with a management server of the ISP (i.e., internet access provider) with which the new subscriber is also associated.

With continuing reference to FIG. 3, a first subscriber uses the STB to send a request 52 to the IPTV server selecting a live TV channel. Based on the source IP address of the STB, the IPTV server looks up the IP address, port, and communication protocol 54 for the proxy server of the ISP with which the first subscriber is also associated. Next, the IPTV server sends a message 56 to that proxy server requesting an IP multicast group IP address for the select live TV channel. In response, the proxy server sends a message 58 with an IP multicast group IP address available for providing the select live TV channel.

At this point, the ISP core network starts to handle the IGMP signaling messages for the select live TV channel associated with the IP multicast group IP address. The IPTV server sends a message 60 to the proxy server informing the proxy server of the source IP address and source port for the IPTV unicast video stream for the select live TV channel. Next, the IPTV server start streaming video data for the select live TV channel via an IPTV unicast video stream 62 to the proxy server in the ISP core network. The proxy server converts the unicast traffic (i.e., IPTV unicast video stream 62) into multicast traffic (i.e., IPTV multicast video stream 64).

Next, the IPTV server sends a message 66 to the STB for the first subscriber indicating that the ISP will provide the select live TV channel to the subscriber after receipt of a message from the STB requesting to join the assigned IP multicast group IP address. After sending an IGMP join message 68 to the proxy server, the STB for the first subscriber begins receiving 70 the IPTV multicast video steam 64. If another subscriber associated with the same ISP uses another STB to send a request 72 for the same live TV channel to the IPTV server, the IPTV server sends a message 74 to the STB for the corresponding subscriber indicating that the ISP will provide the select live TV channel to the corresponding subscriber after receipt of a message from the corresponding STB requesting to join the assigned IP multicast group IP address. After sending an IGMP join message 76 to the proxy server, the corresponding STB for the corresponding subscriber begins receiving 78 the same IPTV multicast video steam 64.

After determining that the STBs associated with subscribers that joined the IPTV multicast video stream are no longer watching the select live TV channel, the proxy server may sends a message to IPTV server to revoke the allocated IP multicast group IP address. In response, the IPTV server stops the unicast streaming of the select live TV channel to the proxy server in the ISP core network.

In another embodiment, the multicast group IP addresses for an ISP may be statically stored in IPTV server for the third party IPTV service provider.

As persons skilled in the art will recognize, subscribers to third party IPTV services may be spread over numerous ISPs, big and small. However, it is not necessary for the third party IPTV server to deploy IPTV servers for each ISP (i.e., internet access provider) with which its subscribers are also associated. Moreover, the IP multicast group IP addresses allocated by each ISP are most likely different from other ISPs. Under these circumstances, IPTV server will send a second unicast stream to a second ISP if the same live TV channel is selected by a third party IPTV subscriber that is not associated with the ISP currently providing an IPTV multicast video stream for the select live TV channel to other subscribers.

The various techniques for providing third party IPTV services to subscribers via IPTV multicast video streams described herein provide third party IPTV subscribers with guaranteed quality of service which provides opportunities for third party IPTV service providers to gain more subscribers. Moreover, ISPs can share revenue with third party IPTV service providers in providing third party IPTV service. As network data traffic grows exponentially year over year, the current problems identified and resolved herein may become more and more useful.

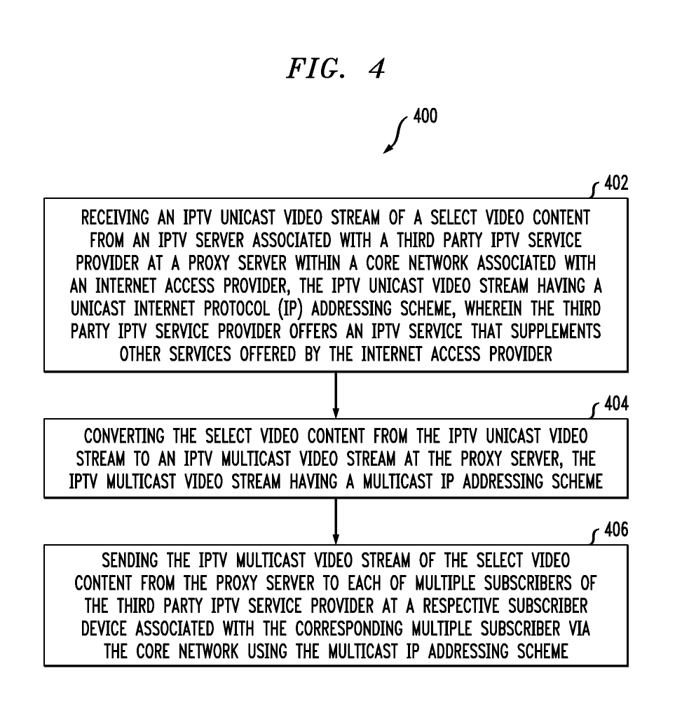

With reference to FIG. 4, an exemplary embodiment of a process 400 for delivery of IPTV service begins at 402 where an IPTV unicast video stream of a select video content is received from an IPTV server associated with a third party IPTV service provider at a proxy server within a core network associated with an internet access provider. The IPTV unicast video stream may utilize a unicast IP addressing scheme. The third party IPTV service provider may be offering an IPTV service that supplements other services offered by the internet access provider. Next, the select video content from the IPTV unicast video stream is converted to an IPTV multicast video stream at the proxy server (404). The IPTV multicast video stream may utilize a multicast IP addressing scheme. At 406, the IPTV multicast video stream of the select video content may be sent from the proxy server to each of multiple subscribers of the third party IPTV service provider at a respective subscriber device associated with the corresponding multiple subscriber via the core network using the multicast IP addressing scheme.

In another embodiment, the process 400 also includes receiving subscriber information from the IPTV server at the proxy server for each of the multiple subscribers of the third party IPTV service provider in relation to the corresponding subscriber signing up with the third party IPTV service provider as a new customer via the core network using the respective subscriber device. In yet another embodiment, the process 400 also includes receiving a source message from the IPTV server at the proxy server, the source message comprising a source IP address and a source port associated with the IPTV server for the IPTV unicast video stream of the select video content.

In still another embodiment of the process 400, the receiving in 402 begins after the IPTV server receives a content request for the select video content from at least a first subscriber of the multiple subscribers using corresponding subscriber devices to access the IPTV server through the internet access provider via the core network. In another embodiment, the process 400 also includes receiving a multicast request to join the IPTV multicast video stream for each of the multiple subscribers from the respective subscriber device associated with the corresponding multiple subscriber via the core network, wherein the sending in 406 to each of the multiple subscribers is in response to receiving the multicast request from the corresponding multiple subscriber. In yet another embodiment, the process 400 also includes sending a stop message to the IPTV server from the proxy server to end the IPTV unicast video stream of the select video content from the IPTV server in response to determining the subscriber devices associated with the multiple subscribers that joined the IPTV multicast video stream are no longer connected to the IPTV multicast video stream.

In still another embodiment, the process 400 also includes receiving an address request for the IPTV multicast video stream from the IPTV server at the proxy server. In this embodiment, a multicast group IP address is assigned to the IPTV multicast video stream in conjunction with the multicast IP addressing scheme. Next, the assigned multicast group IP address for the IPTV multicast video stream is sent to the IPTV server from the proxy server. In a variation of the embodiment being described, the IPTV server sends the multicast group IP address for the IPTV multicast video stream to each of the multiple subscribers via the core network in response to receiving a content request for the select video content from the corresponding multiple subscriber via the core network. In this embodiment, each of the multiple subscribers sends a join message to the proxy server via the core network to join the IPTV multicast video stream of the select video content using the assigned multicast group IP address. In another variation of the embodiment being described, the process 400 may also include revoking the assigned IP multicast group IP address and releasing resources at the proxy server allocated to support the IPTV multicast video stream in response to determining the subscriber devices associated with the multiple subscribers that joined the IPTV multicast video stream are no longer connected to the IPTV multicast video stream.

In another embodiment, the process 400 may also include assigning a multicast group IP address to the third party IPTV service provider in conjunction with the multicast IP addressing scheme. In this embodiment, the multicast group IP address assigned to the third party IPTV service provider is sent to the IPTV server from the proxy server prior to the receiving in 402. Next, a multicast request for multicasting the select video content from the IPTV server is received at the proxy server via the assigned multicast group IP address in conjunction with the receiving in 402. In a variation of the embodiment being described, the IPTV server sends the multicast group IP address for the IPTV multicast video stream to each of the multiple subscribers via the core network in response to receiving a content request for the select video content from the corresponding multiple subscriber via the core network. In this embodiment, each of the multiple subscribers sends a join message to the proxy server via the core network to join the IPTV multicast video stream of the select video content using the assigned multicast group IP address.

In another embodiment of the process 400, the select video content may include live scheduled program content, real-time video content, or any suitable form of video content in any suitable combination. In yet another embodiment of the process 400, the proxy server may include a router. In still another embodiment of the process 400, the core network may include a local area network, a TV network, a telephone network, a wireless network, a cellular network, a satellite communication network, a fiber optic network, an Ethernet network, a coaxial cable network, a DSL network, or any type of communication network suitable for delivery of streaming video in any suitable combination.

In another embodiment of the process 400, the internet access provider may include an internet service provider, a TV service provider, a cable TV service provider, a satellite TV service provider, a telephone service provider, a wireless service provider, a cellular telephone service provider, a satellite communication service provider, or any suitable type of service provider suitable for delivery of streaming video in any suitable combination. In yet another embodiment of the process 400, at least a portion of the signaling for the IPTV multicast video stream complies with an internet group management protocol (IGMP) or any IP protocol suitable for delivery of streaming video in any suitable combination.

In another embodiment of the process 400, each subscriber device may include a network interface device and a user device. In a variation of the embodiment being described, each network interface device may include a network interface unit, a telephone network interface, a cable TV interface unit, a satellite TV interface unit, a telephone network box, a smart jack, an optical network terminal, a modem, a DSL modem, a cable modem, or any suitable network interface device in any suitable combination. In another variation of the embodiment being described, each user device may include an STB, a TV, a display device, a computer system, a telephone, a cellular telephone, a satellite telephone, or any suitable user device in any suitable combination.

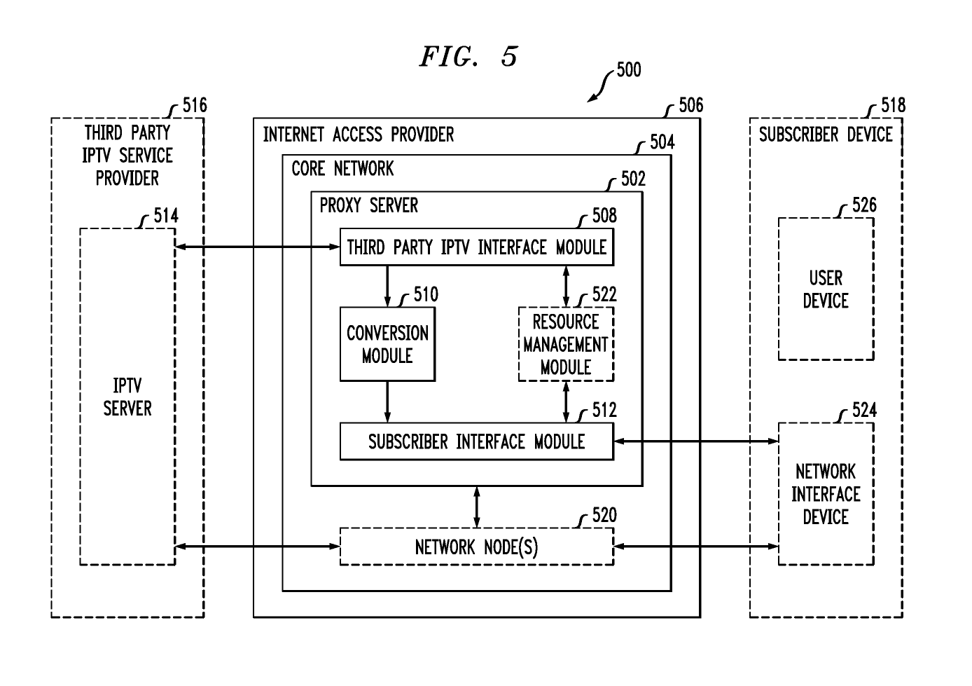

With reference to FIG. 5, an exemplary embodiment of a communication system 500 for delivery of IPTV service includes a proxy server 502 within a core network 504 associated with an internet access provider 506. An exemplary embodiment of the proxy server 502 includes a third party IPTV interface module 508, a conversion module 510 in operative communication with the third party IPTV interface module 508, and a subscriber interface module 512 in operative communication with the conversion module 510.

The third party IPTV interface module 508 may receive an IPTV unicast video stream of a select video content from an IPTV server 514 associated with a third party IPTV service provider 516. The IPTV unicast video stream may utilize a unicast IP addressing scheme. The third party IPTV service provider 516 may offer an IPTV service that supplements other services offered by the internet access provider 506.

The conversion module 510 may convert the select video content from the IPTV unicast video stream to an IPTV multicast video stream. The IPTV multicast video stream may utilize a multicast IP addressing scheme. The subscriber interface module 512 may send the IPTV multicast video stream of the select video content from the proxy server 502 to each of multiple subscribers of the third party IPTV service provider 516 at a respective subscriber device 518 associated with the corresponding multiple subscriber via the core network 504 using the multicast IP addressing scheme.

In another embodiment of the communication system 500, the third party IPTV interface module 508 may receive subscriber information from the IPTV server 514 for each of the multiple subscribers of the third party IPTV service provider 516 in relation to the corresponding subscriber signing up with the third party IPTV service provider 516 as a new customer via the core network 504 using the respective subscriber device 518. Such communications between the subscriber device 518 and the third party IPTV service provider 516 through the core network 504 may be via the proxy server 502, another network node 520, or any suitable combination of network nodes.

In yet another embodiment of the communication system 500, the third party IPTV interface module 508 may receive a source message from the IPTV server 514 comprising a source IP address and a source port associated with the IPTV server 514 for the IPTV unicast video stream of the select video content. In still another embodiment of the communication system 500, the third party IPTV interface module 508 may begin receiving the IPTV unicast video stream after the IPTV server 514 receives a content request for the select video content from at least a first subscriber of the multiple subscribers using corresponding subscriber devices 518 to access the IPTV server 514 through the internet access provider 506 via the core network 504. Such communications between the subscriber device 518 and the third party IPTV service provider 516 through the core network 504 may be via the proxy server 502, another network node 520, or any suitable combination of network nodes.

In another embodiment of the communication system 500, the subscriber interface module 512 may receive a multicast request to join the IPTV multicast video stream for each of the multiple subscribers from the respective subscriber device 518 associated with the corresponding multiple subscriber via the core network 504. In this embodiment, the sending of the IPTV multicast video stream to each of the multiple subscribers may be in response to receiving the multicast request from the corresponding multiple subscriber. In yet another embodiment of the communication system 500, the third party IPTV interface module 508 may send a stop message to the IPTV server 514 to end the IPTV unicast video stream of the select video content from the IPTV server 514 in response to the subscriber interface module 512 determining the subscriber devices 518 associated with the multiple subscribers that joined the IPTV multicast video stream are no longer connected to the IPTV multicast video stream.

In still another embodiment of the communication system 500, the third party IPTV interface module 508 may receive an address request for the IPTV multicast video stream from the IPTV server 514. In this embodiment, the proxy server 502 may also include a resource management module 522 in operative communication with the third party IPTV interface module 508 and the subscriber interface module 512 for assigning a multicast group IP address to the IPTV multicast video stream in conjunction with the multicast IP addressing scheme. In the embodiment being described, the third party IPTV interface module 508 may send the assigned multicast group IP address for the IPTV multicast video stream to the IPTV server 514. In a variation of the embodiment being described, the IPTV server 514 may send the multicast group IP address for the IPTV multicast video stream to each of the multiple subscribers via the core network 504 in response to receiving a content request for the select video content from the corresponding multiple subscriber via the core network 504. In this embodiment, each of the multiple subscribers may send a join message to the subscriber interface module 512 via the core network 504 to join the IPTV multicast video stream of the select video content using the assigned multicast group IP address. Such communications between the subscriber device 518 and the third party IPTV service provider 516 through the core network 504 may be via the proxy server 502, another network node 520, or any suitable combination of network nodes. In another variation of the embodiment being described, the resource management module 522 may revoke the IP multicast group IP address assigned to the IPTV multicast video stream and may release resources allocated to support the IPTV multicast video stream in response to the subscriber interface module 512 determining the subscriber devices 518 associated with the multiple subscribers that joined the IPTV multicast video stream are no longer connected to the IPTV multicast video stream.

In yet another embodiment of the communication system 500, the proxy server 502 may also include a resource management module 522 in operative communication with the third party IPTV interface module 508 and the subscriber interface module 512 for assigning a multicast group IP address to the third party IPTV service provider 516 in conjunction with the multicast IP addressing scheme. In this embodiment, the third party IPTV interface module 508 may send the multicast group IP address assigned to the third party IPTV service provider 516 to the IPTV server 514 prior to the third party IPTV interface module 508 receiving the IPTV unicast video stream of the select video content from the IPTV server 514 and may receive a multicast request for multicasting the select video content from the IPTV server 514 via the assigned multicast group IP address in conjunction with receiving the IPTV unicast video stream. In a variation of the embodiment being described, the IPTV server 514 may send the multicast group IP address for the IPTV multicast video stream to each of the multiple subscribers via the core network 504 in response to receiving a content request for the select video content from the corresponding multiple subscriber via the core network 504. In this embodiment, each of the multiple subscribers may send a join message to the proxy server 502 via the core network 504 to join the IPTV multicast video stream of the select video content using the assigned multicast group IP address. Such communications between the subscriber device 518 and the third party IPTV service provider 516 through the core network 504 may be via the proxy server 502, another network node 520, or any suitable combination of network nodes.

In another embodiment of the communication system 500, the select video content may include live scheduled program content, real-time video content, or any suitable form of video content in any suitable combination. In yet another embodiment of the communication system 500, the proxy server 502 may include a router. In still another embodiment of the communication system 500, the core network 504 may include a local area network, a TV network, a telephone network, a wireless network, a cellular network, a satellite communication network, a fiber optic network, an Ethernet network, a coaxial cable network, a DSL network, or any type of communication network suitable for delivery of streaming video in any suitable combination.

In another embodiment of the communication system 500, the internet access provider 506 may include an internet service provider, a TV service provider, a cable TV service provider, a satellite TV service provider, a telephone service provider, a wireless service provider, a cellular telephone service provider, a satellite communication service provider, or any suitable type of service provider suitable for delivery of streaming video in any suitable combination. In yet another embodiment of the communication system 500, at least a portion of the signaling for the IPTV multicast video stream complies with an internet group management protocol (IGMP) or any IP protocol suitable for delivery of streaming video in any suitable combination.

In another embodiment of the communication system 500, each subscriber device 518 may include a network interface device 524 and a user device 526. In a variation of the embodiment being described, each network interface device 524 may include a network interface unit, a telephone network interface, a cable TV interface unit, a satellite TV interface unit, a telephone network box, a smart jack, an optical network terminal, a modem, a DSL modem, a cable modem, or any suitable network interface device in any suitable combination. In another variation of the embodiment being described, each user device 526 may include an STB, a TV, a display device, a computer system, a telephone, a cellular telephone, a satellite telephone, or any suitable user device in any suitable combination.

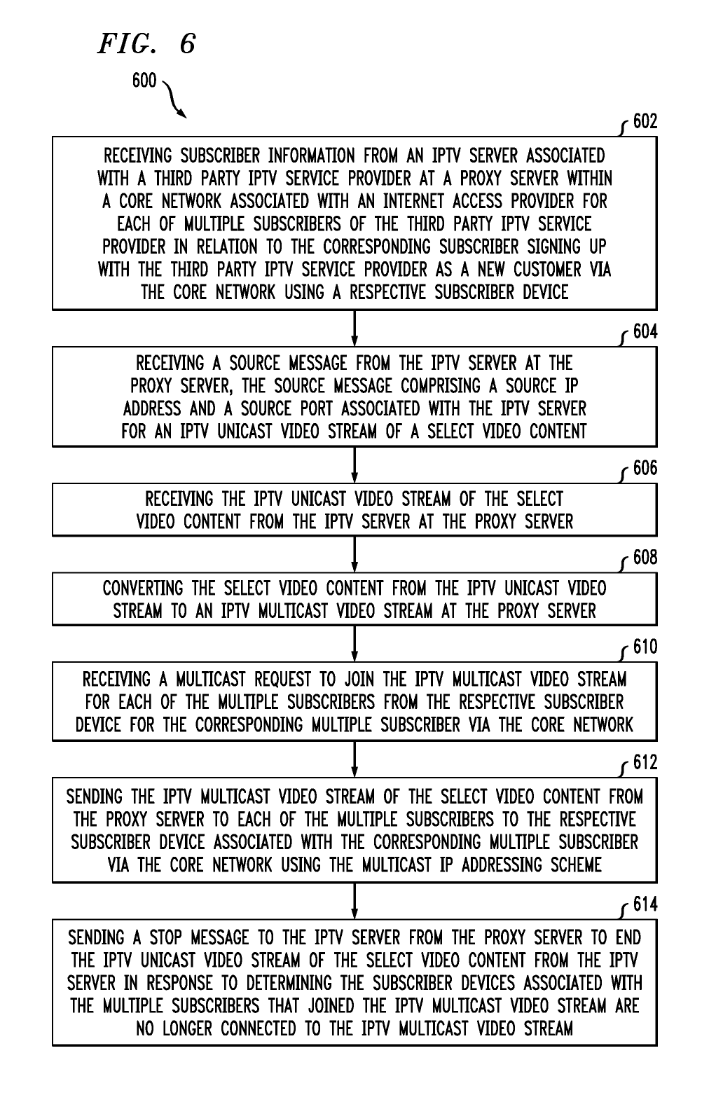

With reference to FIG. 6, an exemplary embodiment of a process 600 for delivery of IPTV service begins at 602 where subscriber information from an IPTV server associated with a third party IPTV service provider is received at a proxy server within a core network associated with an internet access provider for each of multiple subscribers of the third party IPTV service provider in relation to the corresponding subscriber signing up with the third party IPTV service provider as a new customer via the core network using a respective subscriber device. The third party IPTV service provider may be offering an IPTV service that supplements other services offered by the internet access provider. Next, a source message from the IPTV server is received at the proxy server (604). The source message may include a source IP address and a source port associated with the IPTV server for an IPTV unicast video stream of a select video content. At 606, the IPTV unicast video stream of the select video content from the IPTV server is received at the proxy server. The IPTV unicast video stream may utilize a unicast IP addressing scheme. Next, the select video content from the IPTV unicast video stream is converted to an IPTV multicast video stream at the proxy server (608). The IPTV multicast video stream may utilize a multicast IP addressing scheme.

At 610, a multicast request to join the IPTV multicast video stream for each of the multiple subscribers is received from the respective subscriber device for the corresponding multiple subscriber via the core network. Next, the IPTV multicast video stream of the select video content is sent from the proxy server to each of the multiple subscribers to the respective subscriber device associated with the corresponding multiple subscriber via the core network using the multicast IP addressing scheme (612). At 614, a stop message is sent to the IPTV server from the proxy server to end the IPTV unicast video stream of the select video content from the IPTV server in response to determining the subscriber devices associated with the multiple subscribers that joined the IPTV multicast video stream are no longer connected to the IPTV multicast video stream. In this embodiment, the receiving in 606 may begin after the IPTV server receives a content request for the select video content from at least a first subscriber of the multiple subscribers using corresponding subscriber devices to access the IPTV server through the internet access provider via the core network.

In another embodiment, the process 600 also includes receiving an address request for the IPTV multicast video stream from the IPTV server at the proxy server. In this embodiment, a multicast group IP address is assigned to the IPTV multicast video stream in conjunction with the multicast IP addressing scheme. Next, the assigned multicast group IP address for the IPTV multicast video stream is sent to the IPTV server from the proxy server. The assigned IP multicast group IP address is revoked and resources at the proxy server allocated to support the IPTV multicast video stream are released in response to determining the subscriber devices associated with the multiple subscribers that joined the IPTV multicast video stream are no longer connected to the IPTV multicast video stream. In this embodiment, the IPTV server sends the multicast group IP address for the IPTV multicast video stream to each of the multiple subscribers via the core network in response to receiving a content request for the select video content from the corresponding multiple subscriber via the core network. Each of the multiple subscribers sends a join message to the proxy server via the core network to join the IPTV multicast video stream of the select video content using the assigned multicast group IP address.

In yet another embodiment, the process 600 may also include assigning a multicast group IP address to the third party IPTV service provider in conjunction with the multicast IP addressing scheme. In this embodiment, the multicast group IP address assigned to the third party IPTV service provider is sent to the IPTV server from the proxy server prior to the receiving in 606. Next, a multicast request for multicasting the select video content from the IPTV server is received at the proxy server via the assigned multicast group IP address in conjunction with the receiving in 606. In this embodiment, the IPTV server sends the multicast group IP address for the IPTV multicast video stream to each of the multiple subscribers via the core network in response to receiving a content request for the select video content from the corresponding multiple subscriber via the core network. Each of the multiple subscribers sends a join message to the proxy server via the core network to join the IPTV multicast video stream of the select video content using the assigned multicast group IP address.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for delivery of internet protocol television (IPTV) service, comprising:
a) receiving an IPTV unicast video stream of a select video content from an IPTV server associated with a third party IPTV service provider at a proxy server within a core network associated with an internet access provider, the IPTV unicast video stream having a unicast internet protocol (IP) addressing scheme, wherein the third party IPTV service provider offers an IPTV service that supplements other services offered by the internet access provider;
b) converting the select video content from the IPTV unicast video stream to an IPTV multicast video stream at the proxy server, the IPTV multicast video stream having a multicast IP addressing scheme; and
c) sending the IPTV multicast video stream of the select video content from the proxy server to each of multiple subscribers of the third party IPTV service provider at a respective subscriber device associated with the corresponding multiple subscriber via the core network using the multicast IP addressing scheme.

2. The method set forth in claim 1 wherein the receiving in a) begins after the IPTV server receives a content request for the select video content from at least a first subscriber of the multiple subscribers using corresponding subscriber devices to access the IPTV server through the internet access provider via the core network.

3. The method set forth in claim 1, further comprising:
d) receiving a multicast request to join the IPTV multicast video stream for each of the multiple subscribers from the respective subscriber device associated with the corresponding multiple subscriber via the core network, wherein the sending in c) to each of the multiple subscribers is in response to receiving the multicast request from the corresponding multiple subscriber.

4. The method set forth in claim 1, further comprising:
d) sending a stop message to the IPTV server from the proxy server to end the IPTV unicast video stream of the select video content from the IPTV server in response to determining the subscriber devices associated with the multiple subscribers that joined the IPTV multicast video stream are no longer connected to the IPTV multicast video stream.

5. The method set forth in claim 1, further comprising:
d) receiving an address request for the IPTV multicast video stream from the IPTV server at the proxy server;
e) assigning a multicast group IP address to the IPTV multicast video stream in conjunction with the multicast IP addressing scheme; and
f) sending the assigned multicast group IP address for he IPTV multicast video stream to the IPTV server from the proxy server.

6. The method set forth in claim 5 wherein the IPTV server sends the multicast group IP address for the IPTV multicast video stream to each of the multiple subscribers via the core network in response to receiving a content request for the select video content from the corresponding multiple subscriber via the core network.

7. The method set forth in claim 6 wherein each of the multiple subscribers sends a join message to the proxy server via the core network to join the IPTV multicast video stream of the select video content using the multicast group IP address assigned in e).

8. The method set forth in claim 5, further comprising:
g) revoking the IP multicast group IP address assigned in e) and releasing resources at the proxy server allocated to support the IPTV multicast video stream in response to determining the subscriber devices associated with the multiple subscribers that joined the IPTV multicast video stream are no longer connected to the IPTV multicast video stream.

9. The method set forth in claim 1, further comprising:
d) assigning a multicast group IP address to the third party IPTV service provider in conjunction with the multicast IP addressing scheme;
e) sending the multicast group IP address assigned to the third party IPTV service provider to the IPTV server from the proxy server prior to the receiving in a); and
f) receiving a multicast request for multicasting the select video content from the IPTV server at the proxy server via the multicast group IP address assigned in d) in conjunction with the receiving in a).

10. The method set forth in claim 9 wherein the IPTV server sends the multicast group IP address for the IPTV multicast video stream to each of the multiple subscribers via the core network in response to receiving a content request for the select video content from the corresponding multiple subscriber via the core network.

11. The method set forth in claim 10 wherein each of the multiple subscribers sends a join message to the proxy server via the core network to join the IPTV multicast video stream of the select video content using the multicast group IP address assigned in d).

12. An apparatus for delivery of internet protocol television (IPTV) service, comprising:
a proxy server within a core network associated with an internet access provider, the proxy server comprising:
a third party IPTV interface module for receiving an IPTV unicast video stream of a select video content from an IPTV server associated with a third party IPTV service provider, the IPTV unicast video stream having a unicast internet protocol (IP) addressing scheme, wherein the third party IPTV service provider offers an IPTV service that supplements other services offered by the internet access provider;
a conversion module in operative communication with the third party IPTV interface module for converting the select video content from the IPTV unicast video stream to an IPTV multicast video stream, the IPTV multicast video stream having a multicast IP addressing scheme; and
a subscriber interface module in operative communication with the conversion module for sending the IPTV multicast video stream of the select video content from the proxy server to each of multiple subscribers of the third party IPTV service provider at a respective subscriber device associated with the corresponding multiple subscriber via the core network using the multicast IP addressing scheme.

13. The apparatus set forth in claim 12 wherein the third party IPTV interface module sends a stop message to the IPTV server to end the IPTV unicast video stream of the select video content from the IPTV server in response to the subscriber interface module determining the subscriber devices associated with the multiple subscribers that joined the IPTV multicast video stream are no longer connected to the IPTV multicast video stream.

14. The apparatus set forth in claim 12 wherein the third party IPTV interface module receives an address request for the IPTV multicast video stream from the IPTV server, the proxy server further comprising:
a resource management module in operative communication with the third party IPTV interface module and the subscriber interface module for assigning a multicast group IP address to the IPTV multicast video stream in conjunction with the multicast IP addressing scheme;
wherein the third party IPTV interface module sends the assigned multicast group IP address for the IPTV multicast video stream to the IPTV server.

15. The apparatus set forth in claim 14 wherein the resource management module revokes the IP multicast group IP address assigned to the IPTV multicast video stream and releases resources allocated to support the IPTV multicast video stream in response to the subscriber interface module determining the subscriber devices associated with the multiple subscribers that joined the IPTV multicast video stream are no longer connected to the IPTV multicast video stream.

16. The apparatus set forth in claim 12, the proxy server further comprising:
a resource management module in operative communication with the third party IPTV interface module and the subscriber interface module for assigning a multicast group IP address to the third party IPTV service provider in conjunction with the multicast IP addressing scheme;
wherein the third party IPTV interface module sends the multicast group IP address assigned to the third party IPTV service provider to the IPTV server prior to the third party IPTV interface module receiving the IPTV unicast video stream of the select video content from the IPTV server and receives a multicast request for multicasting the select video content from the IPTV server via the assigned multicast group IP address in conjunction with receiving the IPTV unicast video stream.

17. The apparatus set forth in claim 12 wherein each subscriber device comprises a network interface device and a user device.

18. A method for delivery of internet protocol television (IPTV) service, comprising:
a) receiving subscriber information from an IPTV server associated with a third party IPTV service provider at a proxy server within a core network associated with an internet access provider for each of multiple subscribers of the third party IPTV service provider in relation to the corresponding subscriber signing up with the third party IPTV service provider as a new customer via the core network using a respective subscriber device, wherein the third party IPTV service provider offers an IPTV service that supplements other services offered by the internet access provider;
b) receiving a source message from the IPTV server at the proxy server, the source message comprising a source IP address and a source port associated with the IPTV server for an IPTV unicast video stream of a select video content;
c) receiving the IPTV unicast video stream of the select video content from the IPTV server at the proxy server, the IPTV unicast video stream having a unicast internet protocol (IP) addressing scheme;
d) converting the select video content from the IPTV unicast video stream to an IPTV multicast video stream at the proxy server, the IPTV multicast video stream having a multicast IP addressing scheme;
e) receiving a multicast request to join the IPTV multicast video stream for each of the multiple subscribers from the respective subscriber device for the corresponding multiple subscriber via the core network;
f) sending the IPTV multicast video stream of the select video content from the proxy server to each of the multiple subscribers to the respective subscriber device associated with the corresponding multiple subscriber via the core network using the multicast IP addressing scheme; and
g) sending a stop message to the IPTV server from the proxy server to end the IPTV unicast video stream of the select video content from the IPTV server in response to determining the subscriber devices associated with the multiple subscribers that joined the IPTV multicast video stream are no longer connected to the IPTV multicast video stream;
wherein the receiving in c) begins after the IPTV server receives a content request for the select video content from at least a first subscriber of the multiple subscribers using corresponding subscriber devices to access the IPTV server through the internet access provider via the core network.

19. The method set forth in claim 18, further comprising:
h) receiving an address request for the IPTV multicast video stream from the IPTV server at the proxy server;
i) assigning a multicast group IP address to the IPTV multicast video stream in conjunction with the multicast IP addressing scheme;
j) sending the assigned multicast group IP address for the IPTV multicast video stream to the IPTV server from the proxy server; and
k) revoking the IP multicast group IP address assigned in i) and releasing resources at the proxy server allocated to support the IPTV multicast video stream in response to determining the subscriber devices associated with the multiple subscribers that joined the IPTV multicast video stream are no longer connected to the IPTV multicast video stream;
wherein the IPTV server sends the multicast group IP address for the IPTV multicast video stream to each of the multiple subscribers via the core network in response to receiving a content request for the select video content from the corresponding multiple subscriber via the core network;
wherein each of the multiple subscribers sends a join message to the proxy server via the core network to join the IPTV multicast video stream of the select video content using the multicast group IP address assigned in i).

20. The method set forth in claim 18, further comprising:
h) assigning a multicast group IP address to the third party IPTV service provider in conjunction with the multicast IP addressing scheme;
i) sending the multicast group IP address assigned to the third party IPTV service provider to the IPTV server from the proxy server prior to the receiving in c); and
j) receiving a multicast request for multicasting the select video content from the IPTV server at the proxy server via the multicast group IP address assigned in h) in conjunction with the receiving in c);
wherein the IPTV server sends the multicast group IP address for the IPTV multicast video stream to each of the multiple subscribers via the core network in response to receiving a content request for the select video content from the corresponding multiple subscriber via the core network;
wherein each of the multiple subscribers sends a join message to the proxy server via the core network to join the IPTV multicast video stream of the select video content using the multicast group IP address assigned in h).
